(19) United States
(12) Patent Application Publication
(10) Pub. No.: US 2008/0007602 A1
(43) Pub. Date: Jan. 10, 2008

(54) Ink cartridge

(75) Inventor: Myung-song Jung, Gunpo-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/652,019

(22) Filed: Jan. 11, 2007

(30) Foreign Application Priority Data
Jul. 10, 2006 (KR) 2006-64466

(51) Int. Cl. B41J 2/175

(52) U.S. Cl. 347/86

(57) ABSTRACT

An ink cartridge includes a body divided into an ink chamber into which ink is filled and a collecting chamber collecting excess remaining ink after ink is ejected, an ink supply unit formed on a lower portion of the body to receive the ink from the ink chamber and to discharge the excess remaining ink to the collecting chamber after the ink is ejected, and a printhead coupled to a lower portion of the ink supply unit to eject the ink. The ink supply unit is divided into a supply port to receive the ink from the ink chamber and a collection port to receive the excess remaining ink after the ink is ejected through the printhead and to discharge the excess remaining ink to the collecting chamber, and the printhead faces only the collection port and receives ink from the supply port at one side adjacent to the supply port, so that air bubbles generated by the printhead are gathered only in the collection port.

### CROSS-REFERENCE TO RELATED APPLICATIONS

This application claims priority of Korean Patent Application No. 10-2006-0064466, filed on Jul. 10, 2006, in the Korean Intellectual Property Office, the disclosure of which is incorporated herein in its entirety by reference.

### BACKGROUND OF THE INVENTION

1. Field of the Invention

The present general inventive concept relates to an ink cartridge.

2. Description of the Related Art

Inkjet printers can use an electro-thermal transducer (bubble jet method) or an electro-mechanical transducer to eject ink. The electro-thermal transducer generates heat to form bubbles which expand and eject the ink, and the electro-mechanical transducer is a piezoelectric material which generates pressure to eject the ink.

An inkjet printer includes an ink cartridge which stores ink and a printhead which receives ink from the ink cartridge and ejects the ink onto a printing medium according to an image signal.

Air bubbles can be introduced into the ink cartridge as follows: (1) air bubbles can remain in the ink cartridge when the ink cartridge is filled with ink, (2) air bubbles can be introduced into the ink cartridge from an ink feeding unit, (3) air dissolved in the ink can be released due to a temperature change, (4) air bubbles can be introduced into the ink cartridge to keep the pressure in the ink cartridge constant, (5) when the printhead operates, air bubbles can be introduced into the ink cartridge from a print nozzle due to an unstable meniscus in the nozzle, and (6) when the printhead operates, ink can be vaporized due to an increase of temperature.

Air bubbles introduced into the ink cartridge stay in an ink supply path, and thus ink flow of the ink cartridge is obstructed due to the surface tension of the air bubbles.

Particularly, when a filter is installed or provided in an ink supply path between the ink cartridge and the printhead, to remove foreign substances, air bubbles can gather on the downstream side of the filter and greatly impede ink flow.

When the printhead is used in this state, printed images have a low optical density (e.g., image too light). Sometimes, the air bubbles can completely disable the printhead (e.g., a portion of an image or the entire image may not be printed).

### SUMMARY OF THE INVENTION

The present general inventive concept provides an ink cartridge that smoothly supplies ink to a printhead by preventing air bubbles from gathering in an ink supply path between the ink cartridge and the printhead.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an ink cartridge including: a body divided into an ink chamber in which ink is held and a collecting chamber to collect excess remaining ink after the ink is ejected (by the printhead); an ink supply unit formed on a lower portion of the body to receive the ink from the ink chamber and discharge remaining ink to the collecting chamber after the ink is ejected; and a printhead coupled to a lower portion of the ink supply unit to eject the ink, wherein the ink supply unit is divided into a supply port to receive the ink from the ink chamber and a collection port to receive the excess remaining ink after the ink is ejected through the printhead and is discharged to the collecting chamber, and the printhead faces only the collection port and receives ink from the supply port at one side adjacent to the supply port, so that bubbles generated from the printhead are gathered only in the collection port.

The foregoing and/or other aspects and utilities of the present general inventive concept may also be achieved by providing a method of preventing infiltration of generated gas bubbles in an ink supply unit of an ink cartridge, the ink supply unit having a supply port and a collection port to direct the generated gas bubbles away from the supply port.

The foregoing and/or other aspects and utilities of the present general inventive concept may also be achieved by providing an ink supply unit that includes a supply port to receive ink and supply the ink to the printhead; a collection port to receive remaining ink not supplied; a passage between the supply port and the collection port; and a barrier between the supply port and the collection port to prevent generated gas bubbles from entering into the supply port from the collection port or the printhead.

The foregoing and/or other aspects and utilities of the present general inventive concept may also be achieved by providing an ink supply unit to supply ink to a printhead from an ink cartridge, the ink supply unit including an ink supply region to receive ink from the ink cartridge to supply the ink toward a bottom portion of the ink supply unit; a passage disposed at the bottom of the ink supply unit to guide the supplied ink toward the printhead; and a discharge region disposed adjacent to the ink supply region and above the printhead to receive remaining ink not supplied to the printhead and any gases received from the ink supply region and/or the printhead.

The ink supply unit may also include a barrier wall dividing the ink supply region from the discharge region and forming the passage between the ink supply region and the discharge region.

A via hole may be disposed on a backside of the printhead and the printhead may be disposed on a collection port side of the ink supply unit.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view of an ink cartridge according to an embodiment of the present general inventive concept;

FIG. 2 is a cross-sectional view of an ink supply unit and a printhead of the ink cartridge depicted in FIG. 1 according to an embodiment of the present general inventive concept;

FIG. 3 is a cross-sectional view illustrating an ink supply unit and a printhead of the ink cartridge depicted in FIG. 1, according to another embodiment of the present general inventive concept;

FIG. 4 is a cross-sectional view of an ink cartridge according to another embodiment of the present general inventive concept;

FIG. 5 is a cross-sectional view of an ink supply unit and a printhead of the ink cartridge depicted in FIG. 4, according to an embodiment of the present general inventive concept; and

FIG. 6 is a cross-sectional view of an ink supply unit and a printhead of the ink cartridge depicted in FIG. 4, according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

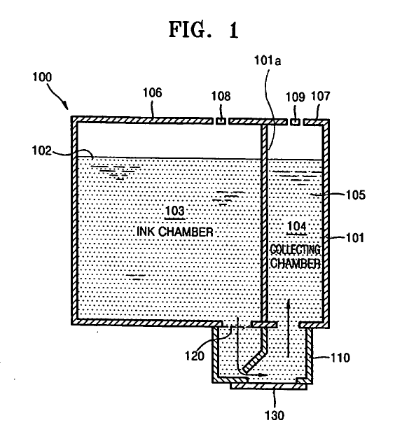

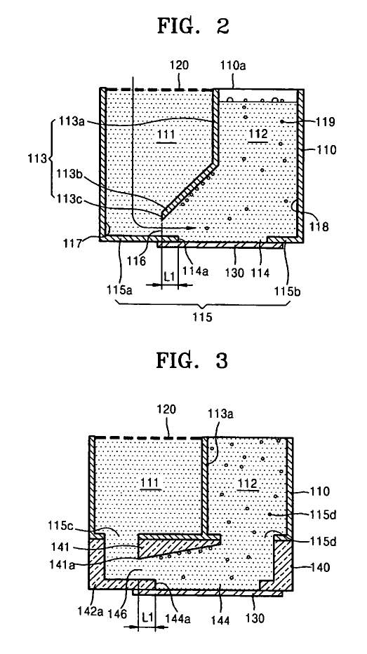

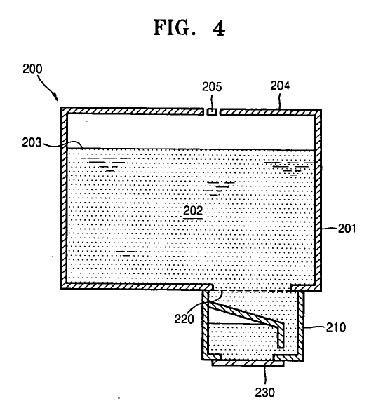

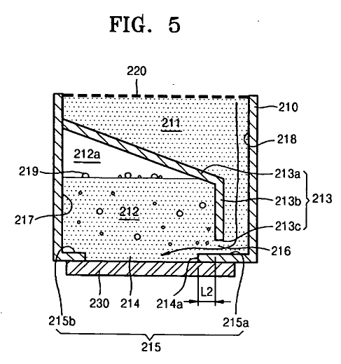

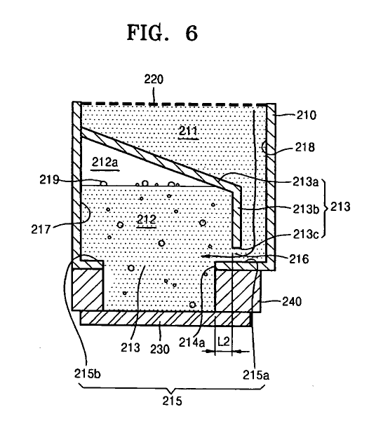

FIG. 1 is a cross-sectional view of an ink cartridge according to an embodiment of the present general inventive concept; FIG. 2 is a cross-sectional view of an ink supply unit and a printhead of the ink cartridge depicted in FIG. 1, according to an embodiment of the present general inventive concept; and FIG. 3 is a cross-sectional view of an ink supply unit and a printhead of the ink cartridge depicted in FIG. 1, according to another embodiment of the present general inventive concept. FIG. 4 is a cross-sectional view of an ink cartridge according to another embodiment of the present general inventive concept; FIG. 5 is a cross-sectional view of an ink supply unit and a printhead of the ink cartridge depicted in FIG. 4, according to an embodiment of the present general inventive concept; and FIG. 6 is a cross-sectional view of an ink supply unit and a printhead of the ink cartridge depicted in FIG. 4, according to another embodiment of the present general inventive concept.

Referring to the embodiments of FIGS. 1 and 2 of the present general inventive concept, an ink cartridge 100 is designed to receive ink from an outside ink source (not illustrated) and discharge the remaining ink containing air bubbles to the outside for collection. The ink cartridge 100 includes a body 101, an ink supply unit 110, and a printhead 130.

Referring to FIG. 1, according to an embodiment of the present general inventive concept, the body 101 includes an ink chamber 103 and a collecting chamber 104, divided by a compartment wall 101a. The ink chamber 103 receives and stores ink 102 from the outside ink source (not illustrated). After the ink 102 is ejected through the printhead 130, the collecting chamber 104 collects remaining ink 105 which contains air bubbles.

The ink chamber 103 includes an upper portion 106 in which a supply valve 108 is formed to receive ink. The collecting chamber 104 includes an upper portion 107 in which a collecting valve 109 is formed to collect the remaining ink 105 from the collecting chamber 104. The supply valve 108 and the collecting valve 109 can be controlled by a controller (not illustrated).

Pursuant to an embodiment of the present general inventive concept, the ink supply unit 110 is formed on a lower portion of the body 101 so as to supply the ink 102 to the printhead 130 and collect ink remaining (e.g., excess) after the printhead 130 ejects the ink 102 needed to conduct the printing operation. Referring to the embodiments of FIGS. 2 and 3 of the present general inventive concept, the ink supply unit 110 includes a supply port 111 and a collection port 112 divided by a barrier wall 113. A via hole 114 is formed in a bottom portion 115 of the ink supply unit 110 where the printhead 130 is attached, to allow the ink 102 to flow therethrough. That is, the ink 102 can be supplied to the printhead 130 through the via hole 114.

The supply port 111 communicates with the ink chamber 103, and the collection port 112 communicates with the collecting chamber 104. Therefore, the ink 102 stored in the ink chamber 103 can flow to the collecting chamber 104 through the supply port 111 and through the collection port 112.

According to the embodiment of FIG. 2, the barrier wall 113 includes a vertical barrier plate 113a and a sloped barrier wall 113b. Also as illustrated in the embodiment of FIG. 2, the vertical barrier plate 113a runs from a top portion 110a to the bottom portion 115 of the ink supply unit 110, parallel with one inner wall 117 of the ink chamber 103 and another inner wall 118 of the collecting chamber 104. An alternative configuration is illustrated in the embodiment of FIG. 3 of the present general inventive concept which will be described infra. Referring to the embodiments of FIGS. 1 and 2 of the present general inventive concept, the sloped barrier plate 113b extends from the vertical barrier plate 113a and passes over the via hole 114 at an angle (see FIG. 2).

Referring to FIGS. 1 and 2, the bottom portion 115 includes the via hole 114, a first bottom portion 115a facing the supply port 111, and a second bottom portion 115b facing the collection port 112.

Since one end 113c of the sloped barrier plate 113b is spaced a predetermined distance from the first bottom portion 115a, a passage 116 is formed between the end 113c and the first bottom portion 115a, allowing the ink 102 to flow from the supply port 111 to the collection port 112.

The end 113c of the sloped barrier plate 113b is spaced a distance L1 apart from one side 114a of the via hole 114 in a direction extending along a length of the bottom portion 115. Therefore, the opening of the passage 116 is displaced by the distance L1 apart from the side 114a.

Referring to FIG. 2, as a result, because the passage 116 is spaced the distance L1 from the end 114a (of the via hole 114) toward the inner wall 117, the ink 102 passing through the passage 116 from the supply port 111 is directed only to the side 114a of the via hole 114, and air bubbles 119 generated by the printhead 130 do not intrude into the supply port 111. Some of the air bubbles 119 generated by the printhead 130 are guided by the sloped barrier plate 113b (away from the supply port 111) to an upper portion of the collection port 112 while other generated bubbles (e.g., air) 119 travel directly to the upper portion of the collection port 112. Therefore, the bubbles 119 are kept away from intruding into the supply port 111 and ultimately interfering with ink flow between the ink chamber 103 and the ink supply unit 110 at, for example, the filter 120.

Referring to FIGS. 1, 2, and 3, a filter 120 is provided between the ink chamber 103 and the supply port 111 to filter out foreign substances, according to embodiments of the present general inventive concept. As explained above, since the air bubbles 119 are not introduced into the supply port 111, the filter 120 does not suffer from air bubble related problems and the ink 102 can flow smoothly from the ink chamber 103 to the supply port 111 through the filter 120.

Referring to the embodiment of FIG. 3 of the present general inventive concept, the ink cartridge 100 further includes a bonding layer 140 between the ink supply unit 110 and the printhead 130 to increase a bonding strength between the ink supply unit 110 and the printhead 130.

Especially when the ink supply unit 110 and the printhead 130 are formed of different materials, the supply unit 110 and the printhead 130 can be poorly bonded. In such a case, the bonding layer 140 can provide a good bonding between the ink supply unit 110 and the printhead 130.

In the embodiment illustrated in FIG. 3, the ink supply port 111 and the collection port 112 are divided only by the vertical barrier plate 113a without the sloped barrier plate 113b used in the embodiment illustrated in FIG. 2. However, here the bottom portion 115 includes a supply hole 115c to communicate with the supply port 111 and a collecting hole 115d to communicate with the collection port 112.

Referring to the embodiment of FIG. 3 a sloped portion 141 is formed in the bonding layer 140 under the ink supply unit 110, instead of the sloped barrier plate 113b illustrated in the embodiment of FIG. 2 of the present general inventive concept.

Like the sloped barrier plate 113b illustrated in the embodiment of FIG. 2, the sloped portion 141 extends from one side 144a of a via hole 144 toward a first bottom portion 142a of the bonding layer 140 facing the supply hole 115c, to overlap with the first bottom portion 142a by a distance L1. Therefore, a passage 146 formed between one end 141a of the sloped portion 141 and the first bottom portion 142a is horizontally displaced by the distance L1 from the side 144a of the via hole 144 toward the supply hole 115c. Thus, the sloped portion 141 illustrated in the embodiment of FIG. 3 provides the same (or similar) function (e.g., to prevent bubble formation or infiltration into supply port 111 through passage 146 or otherwise) as that of the sloped barrier plate 113b of the embodiment illustrated in FIG. 2 of the present general inventive concept.

Alternatively, the ink supply unit 110 can have the same structure as in the embodiment illustrated in FIG. 2, and a bonding layer can be provided between the printhead 130 and the ink supply unit 110.

An ink cartridge will now be described in detail according to another embodiment of the present general inventive concept.

Referring to the embodiments of FIGS. 4 and 5 of the present general inventive concept, an ink cartridge 200 includes a body 201 to receive ink from an outside ink source (not illustrated), an ink supply unit 210, and a printhead 230.

Referring to FIG. 4, the body 201 includes an ink chamber 202 to receive and store ink 203. A supply valve 205 is provided on a top portion 204 of the ink chamber 202 to receive ink 203 from an outside source (not illustrated). The supply valve 205 can be controlled by a controller (not illustrated).

Still referring to FIG. 4, the ink supply unit 210 may be formed on a lower portion of the body 201 so as to supply the ink 203 to the printhead 230. Referring to the embodiments of FIGS. 4, 5 and/or 6 of the present general inventive concept, the ink supply unit 210 includes a supply port 211 and a discharge port 212, divided by a barrier wall 213. A via hole 214 is formed in a bottom portion of the ink supply unit 210 where the printhead 230 is attached, to allow the ink 203 to flow therethrough. That is, the ink 203 can be supplied to the printhead 230 through the via hole 214.

Referring to FIGS. 4, 5 and/or 6, the supply port 211 communicates with the ink chamber 202. Therefore, the ink 203 stored in the ink chamber 202 can flow to the discharge port 212 through the supply port 211.

Still referring to the embodiments of FIGS. 4, 5 and/or 6 of the present general inventive concept, the barrier wall 213 includes a sloped barrier plate 213a and a vertical barrier wall 213b. The sloped barrier plate 213a extends at an angle from one inner wall 217 of the ink supply unit 210 toward the other inner wall 218 of the ink supply unit 210 facing the supply port 211. The vertical barrier plate 213b extends from the sloped barrier plate 213a in parallel with the inner walls 217 and 218 and in perpendicular to a bottom portion 215 of the ink supply unit 210.

Referring to the embodiments of FIGS. 4, 5 and/or 6, the bottom portion 215 includes the via hole 214, a first bottom portion 215a facing the supply port 211, and a second bottom portion 215b facing the discharge port 212.

Since one end 213c of the vertical barrier plate 213b is spaced a predetermined distance from the first bottom portion 215a, a passage 216 is formed between the end 213c and the first bottom portion 215a, allowing the ink 203 to flow from the supply port 211 to the discharge port 212.

The vertical barrier plate 213b is displaced a distance L2 apart from one side 214a of the via hole 214 toward the inner wall 218 along a direction of the length of the bottom portion 115. Therefore, the end 213c of the vertical barrier plate 213b is displaced the distance L2 from one side 214a of the via hole 214 toward the inner wall 218. Thus, the passage 216 formed between the end 213c and the first bottom portion 215a is displaced by the distance L2 apart from the one side 214a of the via hole 214 toward the inner wall 218.

As a result, because the passage 216 is spaced the distance L2 from the end 214a of the via hole 214 toward the inner wall 218, the ink 203 passing through the passage from the supply port 211 is directed only to the side 214a of the via hole 214, and air bubbles 219 generated by the printhead 230 do not intrude into the supply port 211. The air bubbles 219 generated by the printhead 230 (or generated or present in the ink supply unit) are gathered in an upper portion of the discharge port 212. A buffer region 212a is formed at the upper portion of the discharge port 212, and the air bubbles 219 are gathered in the buffer region 212a, according to the embodiments of FIGS. 4, 5 and 6 of the present general inventive concept.

Therefore, the air bubbles 219 are effectively prevented from entering the supply port 211, pursuant to an embodiment of the present general inventive concept.

A filter 220 is provided between the ink chamber 202 and the supply port 211 to filter out foreign substances. As explained above, since the air bubbles 219 are not introduced into the supply port 211, the filter does not suffer from air bubble related problems and the ink 203 can flow smoothly from the ink chamber 202 to the supply port 211 through the filter 220.

Referring to the embodiment of FIG. 6, the ink cartridge 200 further includes a bonding layer 240 between the ink supply unit 210 and the printhead 230 to increase bonding strength between the ink supply unit 210 and the printhead 230.

In the embodiment of FIG. 6, the ink supply unit 210 has the same structure as in the embodiment shown in FIG. 5, and the bonding layer 240 is added between the ink supply unit 210 and the printhead 230. Therefore, the ink supply unit 210 and the printhead 230 of the embodiment of FIG. 6 of the present general inventive concept perform essentially the same operation as that of the embodiment illustrated in FIG. 5.

As described above, in the ink cartridge according to various embodiments of the present general inventive concept, air bubbles are not allowed to enter the ink supply port, and thus do not block any filters along the ink supply path. Therefore, the ink cartridge can supply ink smoothly with improved performance, ejecting ink droplets of uniform size. Accordingly, high image quality is maintained.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink cartridge comprising:
a body divided into an ink chamber into which ink is filled and a collecting chamber to collect excess remaining ink after ink is ejected;
an ink supply unit formed on a lower portion of the body to receive the ink from the ink chamber and to discharge the excess remaining ink to the collecting chamber after the ink is ejected; and
a printhead coupled to a lower portion of the ink supply unit to eject the ink,
wherein the ink supply unit is divided into a supply port to receive the ink from the ink chamber and a collection port to receive the excess remaining ink after the ink is ejected through the printhead and is discharged to the collecting chamber, and
the printhead is disposed on a bottom portion of the ink supply unit in communication with the collection chamber so that bubbles generated at or near the printhead do not enter the supply port.

2. The ink cartridge of claim 1, wherein the ink supply unit comprises:
a via hole limited to communicate between the printhead and the collection port;
a passage to connect the supply port to the collection port; and
a barrier wall to prevent the bubbles generated from entering through the passage into the supply port.

3. The ink cartridge of claim 2, wherein the barrier wall comprises:
a vertical barrier plate extending vertically from an upper portion of the ink supply unit toward the via hole; and
a sloped barrier plate extending from the vertical barrier plate to the passage.
wherein the bubbles generated at or near the printhead are directed by the sloped barrier plate away from the supply port.

4. The ink cartridge of claim 2, further comprising a bonding layer formed between the ink supply unit and the printhead to provide a bond between the ink supply unit and the printhead.

5. The ink cartridge of claim 2, further comprising a filter formed between the ink chamber and the supply port to filter out foreign substances.

6. The ink cartridge of claim 2, wherein the via hole is disposed on a backside of the printhead and the printhead is disposed on a collection port side of the ink supply unit.

7. An ink cartridge comprising:
a body into which ink is filled;
an ink supply unit formed on a lower portion of the body; and
a printhead coupled to a bottom portion of the ink supply unit to eject the ink,
wherein the ink supply unit is divided into a supply port to receive the ink from an ink chamber and a discharge port including a buffer region to receive air bubbles generated by the printhead, and
the printhead faces only the discharge port and receives ink from the supply port at one side adjacent to the supply port, so that air bubbles generated by the printhead are gathered in the buffer region of the discharge port without entering the supply port.

8. The ink cartridge of claim 7, wherein the bottom portion of the ink supply unit includes a via hole to communicate with the printhead, a first bottom portion facing both the supply port and the discharge port, and a second bottom portion facing only the discharge port, the via hole separating the first and second bottom portions;
a barrier wall dividing the ink supply unit into the supply port and the discharge port; and
a passage formed between the barrier wall and the first bottom portion so as to connect the supply port and the discharge port, an opening of the passage disposed a predetermined horizontal distance apart from one side of the via hole toward an inner wall of the ink supply unit in contact with the supply port and facing the discharge port without contacting the discharge port.

9. The ink cartridge of claim 8, wherein the barrier wall comprises:
a sloped barrier plate disposed at an angle from an other inner wall opposing the inner wall, the sloped barrier plate extending toward the bottom portion; and
a vertical barrier plate extending vertically from the sloped barrier plate toward the passage.

10. The ink cartridge of claim 9, wherein a buffer region is located under the sloped barrier plate.

11. The ink cartridge of claim 8, further comprising a filter disposed between the ink chamber and the supply port to filter out foreign substances.

12. The ink cartridge of claim 7, further comprising a bonding layer formed between the ink supply unit and the printhead to provide a bond between the ink supply unit and the printhead.

13. An ink supply unit to supply ink to a printhead, the ink supply unit comprising:
a supply port to receive ink and supply the ink to the printhead;
a collection port to receive remaining ink not supplied;
a passage between the supply port and the collection port; and
a barrier between the supply port and the collection port to prevent generated gas bubbles from entering into the supply port from the collection port or the printhead.

14. The ink supply unit of claim 13, wherein the barrier comprises a sloped barrier plate and a vertical barrier plate.

15. The ink supply unit of claim 14, further comprising a filter at an upper portion of the supply port.

16. The ink supply unit of claim 15, further comprising a buffer region in the collection port to collect the generated gas bubbles.

17. The ink supply unit of claim 14, further comprising a printhead.

18. The ink supply unit of claim 17, wherein the ink supply unit is connected to an ink chamber and the filter is disposed between the ink supply unit and the ink chamber.

19. The ink supply unit of claim 18, wherein the ink chamber is contained within a body of a print cartridge.

20. The ink supply unit of claim 13, wherein the barrier comprises a sloped barrier plate or a sloped barrier wedge that slopes upward from the printhead toward the collection port.

21. The ink supply unit of claim 17, further comprising a bonding layer between the printhead and a wall of the ink supply unit to bond the printhead to the ink supply unit.

22. A method of preventing the infiltration of generated gas bubbles in an ink supply unit of an ink cartridge, the ink supply unit having a supply port and a collection port, the method comprises:
providing a barrier between the supply port and the collection port to direct the generated gas bubbles away from the supply port.

23. The method of claim 22, wherein the ink supply unit further comprises:
a passage to supply ink from the supply port, the passage disposed between the supply port and the collection port.

24. The method of claim 23, wherein the barrier comprises a sloped barrier plate and a vertical barrier plate.

25. The method of claim 24, wherein the ink supply unit further comprises a filter at an upper portion of the supply port.

26. The method of claim 25, wherein the ink supply unit further comprises a buffer region in the collection port to collect the generated gas bubbles.

27. The method of claim 26, wherein the ink supply unit further comprises a printhead disposed in communication with the collection port and not in direct communication with the supply port.

28. The method of claim 27, wherein the ink supply unit is connected to an ink chamber and the filter is disposed between the ink supply unit and the ink chamber

29. The method of claim 28, wherein the ink chamber is contained within a body of the ink cartridge.

30. The method of claim 29, wherein the ink supply unit further comprises a bonding layer between the printhead and a wall of the ink supply unit.

31. An ink supply unit to supply ink to a printhead from an ink cartridge, the ink supply unit comprising:
an ink supply region to receive ink from the ink cartridge to supply the ink toward a bottom portion of the ink supply unit;
a passage disposed at the bottom of the ink supply unit to guide the supplied ink toward the printhead; and
a discharge region disposed adjacent to the ink supply region and above the printhead to receive remaining ink not supplied to the printhead and any gases received from the ink supply region and/or the printhead.

32. The ink supply unit of claim 31, further comprising:
a barrier wall dividing the ink supply region from the discharge region and forming the passage between the ink supply region and the discharge region.
